(19) United States
(12) Patent Application Publication
(10) Pub. No.: US 2017/0180171 A1
(43) Pub. Date: Jun. 22, 2017

(54) FREQUENCY SYNCHRONIZATION OF CONVOLUTIONALLY CODED GFSK SIGNALS

(71) Applicant: QUALCOMM Incorporated, San Diego, CA (US)

(72) Inventors: Seyed Mohammad Ehsan HOSSEINI, San Diego, CA (US); RaviKiran GOPALAN, Solana Beach, CA (US); Yu-Han YANG, Santa Clara, CA (US); Markos TROULIS, San Diego, CA (US)

(21) Appl. No.: 14/974,958

(22) Filed: Dec. 18, 2015

(51) Int. Cl. H04L 27/14; H04L 1/00

(52) U.S. Cl. CPC H04L 27/14; H04L 1/0054

(57) ABSTRACT

Systems and methods pertain to a receiver configured to receive and detect convolutionally coded Gaussian frequency-shift keying (GFSK) signals comprising a trellis of branches. The receiver implements a Per-Survivor Processing (PSP) algorithm to generate frequency estimate, phase estimate, and branch metric increment for each branch of a trellis. A Viterbi Algorithm is applied to the trellis for Maximum Likelihood Sequence Estimation (MLSE) of information bits. The receiver includes a PSP block comprising a number of blocks equal to the number of branches of the trellis. Each block includes a Phase Corrector, Decision Feedback Demodulator (DFD), and a Frequency Tracking Loop (FTL) to update the PSP variables.

### FIELD OF DISCLOSURE

Disclosed aspects relate to frequency synchronization of Gaussian frequency-shift keying (GFSK) signals with convolutional codes. More specifically, exemplary aspects relate to frequency synchronization of convolutionally coded GFSK signals using per-surviving processing (PSP).

### BACKGROUND

Frequency modulation schemes may be used in transmitting digital information. A set of symbols which may be used to generate a digital signal is known as an alphabet. Symbols of the alphabet are used to generate signals, modulated to a transmission frequency and transmitted on a communication medium to a receiver. The receiver is configured to demodulate the received signals and detect the signals which were transmitted.

In some examples of frequency modulation, the alphabet has only two symbols, 0 and 1 (also referred to as bits). Frequency shift keying (FSK) is a method by which the symbols 0 and 1 can be translated into signals for transmission. Using FSK, a carrier frequency at which the signals are transmitted is decreased for durations when the symbol 0 is transmitted and increased for durations when the symbol 1 is transmitted. This represents a square-wave signal in the frequency domain. If Gaussian filtering is applied to the square-wave signal, the carrier frequency may be shifted, and this type of modulation is referred to as Gaussian frequency shift keying (GFSK).

GFSK may be used in communication standards such as Bluetooth for signal communication. Detection of GFSK signals at a GFSK receiver involves both phase and frequency tracking. Some applications which use standards such as Bluetooth may involve low cost oscillators which can contribute to jitter, leading to lower signal-to-noise ratios (SNRs) in GFSK signal detection. At low SNRs, error correction codes (ECC) such as convolutional forward error correction (FEC) schemes, which may be employed in transmitting GFSK signals, can hinder frequency tracking.

Accordingly, there is a need in the art for improving phase and frequency tracking in GFSK receivers.

### SUMMARY

Exemplary embodiments of the invention are directed to systems and methods related to a receiver configured to receive and detect convolutionally coded Gaussian frequency-shift keying (GFSK) signals. The receiver implements a Per-Survivor Processing (PSP) algorithm to generate branch metrics or PSP variable such as frequency, phase, and memory for each branch of a trellis. A Viterbi Algorithm is applied to the trellis for Maximum Likelihood Sequence Estimation (MLSE). The receiver includes a PSP block comprising a number of blocks equal to the number of branches of the trellis. Each block includes a Phase Corrector, Decision Feedback Demodulator (DFD), and a Frequency Tracking Loop (FTL) to update the PSP variables.

For example, an exemplary aspect relates to a method of operating a receiver, the method comprising receiving convolutionally coded Gaussian frequency-shift keying (GFSK) signals, and performing a maximum likelihood sequence estimation of a received convolutionally coded GFSK signal using a Viterbi algorithm (VA). Performing the maximum likelihood sequence estimation of the received convolutionally coded GFSK signal using the Viterbi algorithm (VA) comprises Per-Survivor Processing (PSP) of the received convolutionally coded GFSK signal.

Another exemplary aspect relates to an apparatus comprising a receiver. The receiver is configured to receive convolutionally coded Gaussian Frequency-Shift Keying (GFSK) signals; and perform a maximum likelihood sequence estimation (MLSE) of the received convolutionally coded GFSK signals using a Viterbi Algorithm (VA).

Yet another exemplary aspect relates to an apparatus comprising: means for receiving convolutionally coded Gaussian Frequency-Shift Keying (GFSK) signals; and means for performing a maximum likelihood sequence estimation (MLSE) of the received convolutionally coded GFSK signals using a Viterbi Algorithm (VA).

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates a communication system, according to an aspect of this disclosure.

FIG. 2 illustrates a trellis, according to an aspect of this disclosure.

FIG. 3 illustrates a schematic diagram of a receiver, according to an aspect of this disclosure.

FIG. 4 illustrates a schematic diagram of a Per-Survivor Processing (PSP) block of the receiver of FIG. 3, according to an aspect of this disclosure.

FIG. 5 illustrates a schematic diagram of a Phase Corrector of the PSP block of FIG. 4, according to an aspect of this disclosure.

FIG. 6 illustrates a schematic diagram of a Decision Feedback Demodulator (DFD) of the PSP block of FIG. 4, according to an aspect of this disclosure.

FIG. 7 illustrates a schematic diagram of a Frequency Tracking Loop (FTL) of the PSP block of FIG. 4, according to an aspect of this disclosure.

FIGS. 8A-B illustrate another trellis, according to an aspect of this disclosure.

FIG. 9 illustrates a method of operating a receiver, FIG. 2 illustrates a trellis, according to an aspect of this disclosure.

FIG. 10 illustrates an exemplary wireless device in which an aspect of the disclosure may be advantageously employed.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Exemplary aspects of this disclosure pertain to GFSK receivers configured for phase and frequency tracking of GFSK signals which may include convolutional coding (e.g., convolutional forward error correction (FEC) schemes). Exemplary GFSK receivers may support technologies such as Bluetooth Low Energy (LE) or Low Energy Long Range (LELR), etc. For example, an exemplary GFSK receiver is configured to receive GFSK signals which employ a rate half convolutional code. In general, the convolutionally coded GFSK signals comprise a trellis of two or more branches.

By way of background, frequency tracking in rate half convolutional codes can be conventionally implemented with trellis coded modulations (TCM). In TCM, a Viterbi algorithm (VA) may be used for decoding transmitted sequences of signals. Generally speaking, a tentative decision may be made in each step of the VA on a global surviving path and the tentative decision may be used to update phase and frequency tracking loops. Specifically, a technique known as Per-Surviving Processing (PSP) may be used for phase tracking of signals, wherein the VA is used for maximum likelihood sequence estimation (MLSE) of a signal with an unknown phase. A phase estimate is assigned to each state of the trellis and the phase estimate is updated at each state transition through the trellis. With this approach it is seen that a maximum likelihood path in the trellis jointly maximizes the likelihood of transmitted data bits as well as a channel estimate. In the context of phase and frequency tracking of signals using PSP, a phase locked loop (PLL) is assigned to each state of the trellis and a phase error signal is computed for each of branch of the trellis. The VA decides a winner branch for each state. The phase error of the winner branch is then used to update the PLL, which is associated with the state of the winner branch.

However, unlike the PSP algorithms applied to TCM in conventional aspects described above, it is difficult to apply PSP algorithms to GFSK signals because GFSK signals involve a non-linear modulation. In exemplary aspects of this disclosure, the limitations of conventional applications of PSP are overcome. Exemplary aspects involving PSP synchronization applied to convolutionally coded GFSK signals with spreading are discussed in the following sections.

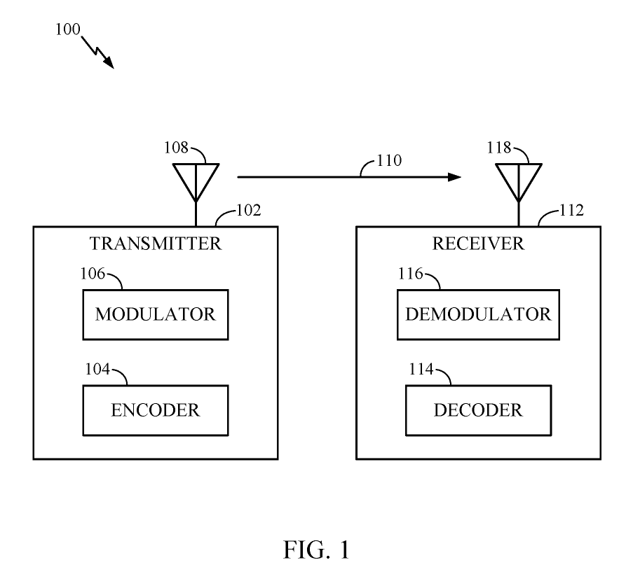

With reference now to FIG. 1, a simplified schematic diagram of an exemplary communication system 100 is illustrated. Communication system 100 comprises transmitter 102 and receiver 112 configured according to exemplary aspects. Communication system 100 can be configured for Bluetooth LE or LELR communication, for example. Transmitter 102 may comprise encoder 104 configured to encode information bits into convolutionally coded bits. Modulator 106 is configured to modulate the convolutionally coded bits into GFSK signals at the carrier frequency of channel 110, and antenna 108 is configured to transmit the convolutionally coded GFSK signals on channel 110. On the receiving end, receiver 112 may comprise antenna 118 configured to receive the convolutionally coded GFSK signals on channel 110, demodulate the convolutionally coded GFSK signals in demodulator 116 and decode the demodulated convolutionally coded GFSK signals in decoder 114.

Considering transmitter 102 in further detail, encoder 104 may be a convolutional encoder. Information bits to be transmitted (which may be received from any computing device or storage medium, not shown) may be provided to encoder 104. Encoder 104 may encode each information bit using N_{c} bits, wherein encoder 104 may generate an output comprising N_{c} bits, also referred to as N_{c} coded bits for each information bit, wherein N_{c} is a positive integer. The N_{c} coded bits form a sequence and state transitions of a sequence of N_{c} coded bits are referred to as a “code word.”

Each coded bit is then sent to a mapper (which may be present in encoder 104), wherein logic values “0” and “1” are mapped into two different sequences of R bits. The operation of mapping “0” and “1” to different sequences of R bits is referred to as “spreading” or “pattern mapping.” The sequences of R bits generated by the mapper are referred to as modulation bits. It is seen that each information bit generates R*N_{c} or “RN_{c}” bits following the encoding and mapping, and therefore, the modulation bits are generated at a rate which is RN_{c} times the rate at which information bits are processed.

Table 1, below, provides an example of spreading with R=4 implemented by a mapper, wherein coded bits are shown as input bits of the mapper and for each input bit, an output sequence of R=4 bits are generated after spreading.

TABLE 1
bit spreading implemented by a mapper

| Input Bit | Output Sequence |
|---|---|
| 0 | 1100 |
| 1 | 0011 |

The output sequence generated by the mapper, or modulation bits, are provided to modulator 106. Modulator 106 may be configured as a GFSK modulator, which may be a binary modulator in some aspects. The output of modulator 106 is a waveform (e.g., a square wave) which is modulated or up-converted to the carrier frequency of channel 110 and sent over channel 110 to receiver 112.

At receiver 112, the signals received on channel 110 are down-converted and demodulated (e.g., by demodulator 116) to a base frequency of receiver 112 (also referred to a baseband frequency). The demodulated signals may be decoded by decoder 114. Decoder 114 may include a sampler configured to sample the demodulated signals, e.g., at a rate of one sample per bit. These samples are denoted by r, with rₙ samples per GFSK bit.

The operation of receiver 112 for demodulating and decoding/detecting coded bits of the received convolutionally coded GFSK signals will now be explained in further detail. In one aspect, receiver 112 can implement a PSP block to detect the received signals. The PSP block will be described by first considering a decision feedback demodulator (DFD) which, as known in the art can be used for detection of coded bits which are not convolutionally coded. A DFD, for example, is known in the art for detection of signals with memory. In exemplary aspects of this disclosure, PSP frequency tracking of convolutionally coded signals can comprise an efficient frequency tracking algorithm applied to the DFD.

The convolutionally coded signals may be representable by one or more GFSK symbols. In cases where the coded signals are represented by two or more GFSK symbols, the coded signals are said to be spread over the two or more GFSK symbols. The DFD can be used to directly detect the coded bits that are represented by one or more GFSK symbols, denoted herein as R GFSK symbols (including in the cases where they are spread over two or more GFSK symbols), based on the following recursive equations

$$\begin{matrix}{\hat{a}}_{k} = {argmax}_{i = 0 , 1} \{ {{M}_{k}^{*} ( {s}^{( i )} )}^{H} {r}_{k} \} \\ {M}_{k + 1} = ( ( 1 - α ) {M}_{k} + {( {s}^{( {\hat{a}}_{k} )} )}^{H} {r}_{k} ) {e}^{j ϕ ( {\hat{a}}_{k} )}\end{matrix}$$

wherein, rₖ is a vector of received samples for the k-th bit aₖ, and 0≦α≦1 is a forgetting factor; sₖ⁽ⁱ⁾ is the vector of transmitted samples for the hypothetical bit i, wherein “i” is the hypothetical value of the k-th bit, i.e. i=0 or i=1. In the above equations, rₖ and sₖ⁽ⁱ⁾ comprise R samples. Mₖ can be interpreted as an estimator for the initial carrier phase offset. Moreover, φ(âₖ) is the amount of phase increment in the transmitted signal during the transmission of âₖ. Note that φ(âₖ) may be pre-computed and stored for aₖ=0 and aₖ=1. Additionally the DFD's memory, i.e. Mₖ, is updated at the rate of the coded bits, which is equivalent to every R samples.

In a perfectly synchronized frequency tracking loop (FTL), the latest frequency estimate \hat{ω}ₖ is assumed to have de-rotated the received signal by \hat{θ}ₖ before the DFD makes a decision, which leads to the equation:

$${\hat{a}}_{k} = {argmax}_{i = 0 , 1} \{ Re \{ {M}_{k}^{*} {{e}^{- j {\hat{ θ}}_{k}} ( {s}^{( i )} )}^{H} {r}_{k} \} \}$$

A frequency drift will cause the operand of the right hand side of the above equation to be rotated away from the real axis due to the error in \hat{ω}ₖ either by a drift or by the estimation error. This excess phase rotation is proportional to the frequency offset error and can be used as the error signal for the FTL update, for example, as per the below equations:

eₖ=arg{M*ₖe^{-jθ}^{ₖ}(s^{(a}^{ₖ}⁾)^{H}r′ₖ}

\hat{ω}ₖ₊₁=\hat{ω}ₖ+γeₖ

wherein, γ is the loop filter coefficient. Additionally, aₖ becomes âₖ in a decision-directed mode (wherein, it will be understood that in training mode or data-aided mode, aₖ is used, because the bit values are known to the receiver in advance). The frequency estimate is then used to update a phase correction value or channel estimate as follows:

\hat{θ}ₖ₊₁=\hat{θ}ₖ+\hat{ω}ₖ₊₁

The above-described method can be used directly at the GFSK symbol rate for faster tracking. For example, consider the following equations

eₙ=arg{M*_{┘n/R┘}e^{-jθ}^{ₙ}(s^{(a}^{ₙ}⁾)*rₙ}

\hat{ω}ₙ₊₁=\hat{ω}ₙ+γeₙ

wherein, s^{(a}^{ₙ}⁾ is the transmitted sample for the n-th GFSK symbol, which is based on the └n/R┘-th coded bit. The channel estimate can therefore also be updated at the GFSK symbol rate, i.e.

\hat{θ}ₙ₊₁=\hat{θ}ₙ+\hat{ω}ₙ₊₁

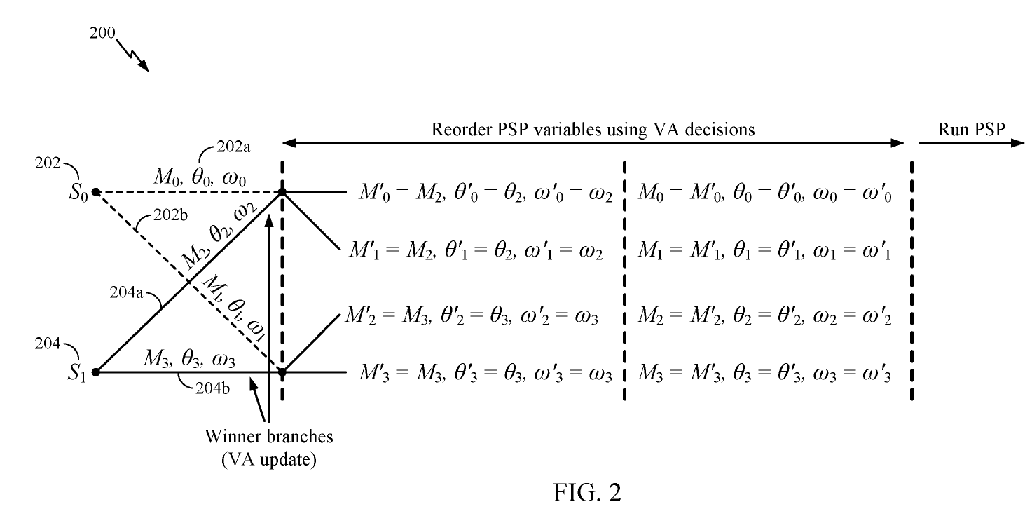

With reference now to FIG. 2, the above operations for FTL and DFD will now be extended to an exemplary PSP implementation. FIG. 2 shows aspects of trellis 200 of branches 202a-b and 204a-b. Specifically, trellis 200 comprises states S₀ 202 and S₁ 204, with branches 202a and 202b pertaining to state S₀ 202 and branches 204a and 204b pertaining to state S₁ 204. Winner branches among these branches for the two states are selected using Viterbi Algorithm (VA). As previously noted, in a trellis coded modulation (TCM) signal, each branch is associated with a single constellation point. However, in the case of a convolutionally coded GFSK signal, each branch is associated with a sequence of multiple (N_{c}) consecutive bits. Therefore, branch metric increments for convolutionally coded GFSK signals are computed based on the transmitted bit sequence of N_{c} bits on each branch.

For convolutionally coded GFSK signals, the trellis of a convolutional code comprises two or more branches, denoted herein as N_{b} branches, each of which corresponds to a transmitted signal. This transmitted signal comprises RN_{c} samples that can be derived from the trellis and the spreading scheme. Since the transmitted signal is known over each branch, the aforementioned DFD and FTL can be applied to the branches of the trellis individually in order to compute the frequency estimates and branch metric increments for the Viterbi Algorithm (VA), which provides the exemplary PSP algorithm which utilizes the FTL and DFD.

For example, consider a branch/of the trellis for a particular state transition (e.g., one of the four branches 202a-b, 204a-b). A set of DFD, FTL, and Phase Corrector are applied to this branch l. During a state transition over this branch, RN_{c} samples are received, e.g., designated as r₀, r₁, . . . , r_{RN}_{_{c}}₋₁. For this set of samples, the DFD and FTL are utilized to update the DFD's memory Mₗ, frequency estimate ωₗ, and phase estimate θₗ. The memory Mₗ, frequency estimate ωₗ, and phase estimate θₗ are referred to herein as PSP variables.

The PSP variables are updated for branch l, and at the same time, the PSP variables are also updated for all other branches of the trellis (e.g., the remaining branches 202a-b, 204a-b). Once the state transitions are completed, the VA is updated to select a winner branch for each state of the trellis. For example, as shown in FIG. 2, branches 204a and 204b are selected as winners for states S₀ 202 and S₁ 204, respectively. The exemplary PSP algorithm uses the VA decision and updates PSP variables for all the branches that are moving out of a particular state with the PSP variables of the winner branch that is merged into that particular state. For example, PSP variables for branches 202a and 202b are updated with PSP variables for winner branches 204a and 204b, respectively. This amounts to effectively reordering PSP variables using the VA decisions. Based on this reordering, frequency/phase can be tracked individually over all surviving paths or branches selected using the VA.

A detailed implementation of receiver 112 based on the exemplary PSP algorithm using FTL and DFD will now be described. Table 2 below provides a list of symbols and their definitions to aid in the explanation.

TABLE 2
symbols used in the exemplary PSP algorithm

| Symbol | Description |
|---|---|
| rₙ | The received signal samples, sampled at the GFSK symbol |
| | rate or the output bit rate of the bit mapper |
| Nₛ | Number of states in the trellis |
| Sₖ | Trellis states, Sₖ ε {S₀, S₂, . . . , S_{N}_{ₛ}₋₁} |
| N_{b} | Number of branches in the trellis |
| bₗ | Trellis branch, bₗ ε {b₀, b₁, . . . , S_{N}_{_{b}}₋₁}. Branches are |
| | indexed from the top branch of S₀ on the left hand side of |
| | the trellis. |
| λₗ | Complex branch metric increment for bₗ for, which is sent |
| | to the VA |
| Mₗ | DFD memory for bₗ |
| ωₗ | Frequency estimate for bₗ |
| θₗ | Phase correction value for bₗ |
| dₖ | The latest VA decision for bₖ, dₖ ε {0,1} |
| cₙ^{l} | The correlation of the n-th received sample and the n-th |
| | transmitted sample over branch bₗ, i.e. cₙ^{l} = rₙ(sₙ^{l})* |
| c′ₙ^{l} | cₙ^{l} rotated by the latest phase estimate, i.e. θₙ¹ |
| M′ₗ | A copy of Mₗ to be used for the PSP memory reordering |
| ω′ₗ | A copy of ωₗ to be used for the PSP memory reordering |
| θ′ₗ | A copy of θₗ to be used for the PSP memory reordering |

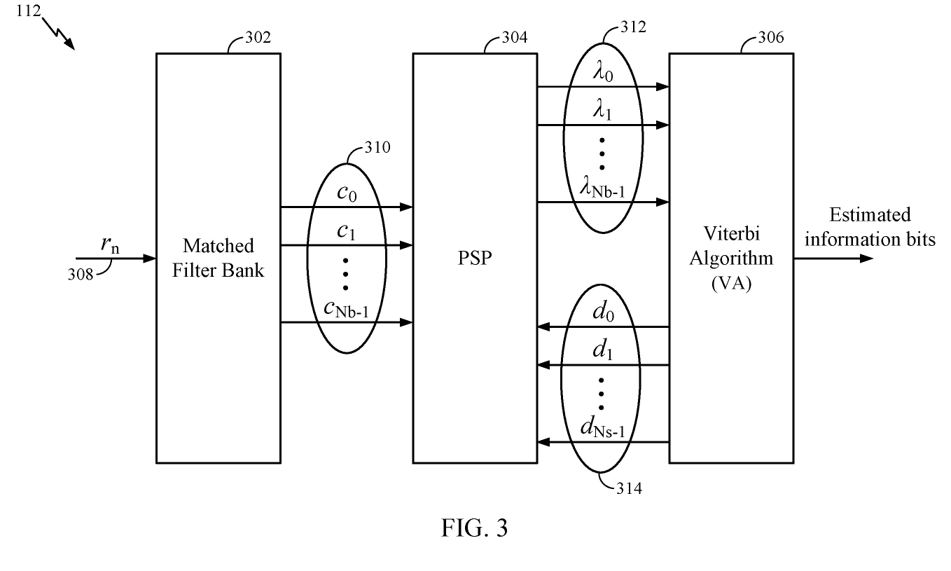

With reference now to FIG. 3, a schematic block diagram for receiver 112 of FIG. 1 is illustrated. FIG. 3 shows an example architecture for receiver 112 configured as a GFSK receiver with PSP according to aspects of this disclosure. In some aspects, matched filter bank 302 and PSP 304 of FIG. 3 may be provided in the block identified as demodulator 116 in FIG. 1 (wherein demodulation and decoding may be jointly performed in demodulator 116 based on the cooperation of matched filter bank 302 and PSP 304 in exemplary aspects). The block identified as Viterbi Algorithm (VA) 306 of FIG. 3 may be provided in the block identified as decoder 114 in FIG. 1.

In further detail, receiver 112 receives convolutionally coded GFSK signals (e.g., from channel 110 through antenna 118, as depicted in FIG. 1), represented as an input or received signal rₙ 308 in FIG. 3. Received signal rₙ 308 is sampled at a rate referred to herein as the GFSK symbol rate (corresponding, for example, to an output bit rate of the bit mapper). For example, received signal rₙ 308 is sampled at the rate of Fs MHz in matched filter bank 302, wherein Fs MHz corresponds to the GFSK symbol rate in received signal rₙ 308. Based on the sampling, matched filter bank 302 generates two or more, or the aforementioned number N_{b}, matched filter outputs c₀, c₁, . . . c_{Nb-1} 310, associated with data in received signal rₙ 308 over N_{b} branches of a trellis.

The N_{b} matched filter outputs c₀, c₁, . . . c_{Nb-1} 310 are provided to PSP 304. As discussed with reference to FIG. 2, VA 306 determines Nₛ decisions of winner branches d₀, d₁, . . . d_{Ns-1} 314. The VA decisions on winner branches d₀, d₁, . . . d_{Ns-1} 314 from VA 306 are updated at an information bit rate by VA 306. In more detail, there are Nₛ VA decisions because the trellis has Nₛ states. VA 306 provides the Nₛ decisions of winner branches d₀, d₁, . . . d_{Ns-1} 314 to PSP 304.

PSP 304 receives the Nₛ decisions of winner branches d₀, d₁, . . . d_{Ns-1} 314 from VA 306 and generates N_{b} branch metric increments λ₀, λ₁, . . . λ_{Nb-1} 312. The N_{b} branch metric increments λ₀, λ₁, . . . λ_{Nb-1} 312 are provided back to VA 306 to be used in the Viterbi Algorithm to update decisions on the winner branches.

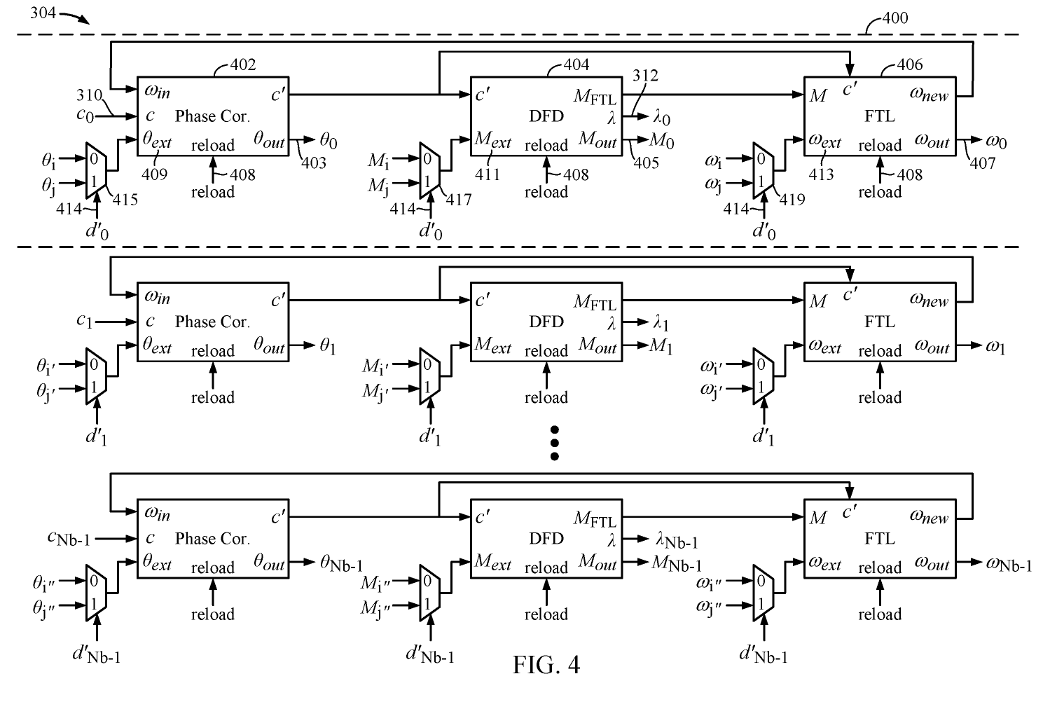

Referring now to FIG. 4, further details of an exemplary implementation of PSP 304 of FIG. 3 are illustrated. As shown in FIG. 4, there are N_{b} rows or sets of blocks corresponding to N_{b} branches of the trellis, each with one of c₀, c₁, . . . c_{Nb-1} 310 as inputs, and one of λ₀, λ₁, . . . λ_{Nb-1} 312 as outputs. Also, there are N_{b} values d′₀, d′₁, . . . d′_{Nb-1} 414 provided, one to each row, wherein the Nₛ decisions of winner branches d₀, d₁, . . . d_{Ns-1} 314 provided by VA 306 are mapped to the N_{b} values d′₀, d′₁, . . . d′_{Nb-1} 414, as explained with reference to FIG. 2 above. For example, if decision d₀ corresponds to the winner branch, then d₀ is used for both of the two branches 202a and 202b starting from state S₀ 202. Similarly, the same decision of a winner branch may be used for both of the two branches 204a and 204b starting from state S₁ 204, and so on. Thus, the decision values d′₀, d′₁, . . . d′_{Nb-1} 414 for each of the N_{b} rows in FIG. 4 represent the Nₛ decisions of winner branches d₀, d₁, . . . d_{Ns-1} 314 mapped according to exemplary aspects.

In one example, N_{b}=16, corresponding to sixteen branches of the trellis. As shown, the first or topmost row identified as row 400, corresponding, for example, to branch b₀, will be explained in further detail, keeping in mind that the remaining rows corresponding to the remaining branches are similarly configured. As shown, row 400 of PSP 304 comprises the blocks identified as Phase Corrector 402, DFD 404, and FTL 406, configured to implement the PSP algorithm. More specifically, Phase Corrector 402, DFD 404, and FTL 406 are configured to generate or update the PSP variables θ₀ 403, M₀ 405, and ω₀ 407 for row 400, respectively. In general, Phase Corrector, DFD, and FTL blocks in each row l are configured to generate θₗ, Mₗ, and ωₗ respectively for that row.

Continuing with the discussion of row 400, each of blocks Phase Corrector 402, DFD 404, and FTL 406 have a memory (not shown) which is reordered once the VA decisions from VA 306 are received and mapped to the decisions used by corresponding branches or rows. Therefore each of blocks Phase Corrector 402, DFD 404, and FTL 406 is provided with a “reload” input coupled to the signal, reload 408, which is configured to trigger memory reordering during a memory reordering phase of the PSP algorithm.

Each of blocks Phase Corrector 402, DFD 404, and FTL 406 also include an “external” input (θₑₓₜ 409, Mₑₓₜ 411, and ωₑₓₜ 413, respectively) which is used to update the internal memory (not explicitly shown in FIG. 4) of the respective block with an external value during the reordering phase. The Phase Corrector, DFD, and FTL blocks for each branch bₗ is updated with the memories of similar Phase Corrector, DFD, and FTL blocks on other branches that merge to a starting state of branch bₗ. The selection between two branches which merge are made according to the mapped VA decisions d′₀, d′₁, . . . d′_{Nb-1} 414. The selection is implemented, for example, using multiplexer at the input of each of blocks Phase Corrector 402, DFD 404, and FTL 406. For example, as shown for branch b₀ in row 400, multiplexers 415, 417, and 419, each controlled by VA decision d′₀ 414 selects PSP variables which will be provided to inputs θₑₓₜ 409, Mₑₓₜ 411, and ωₑₓₜ 413 respectively, of blocks Phase Corrector 402, DFD 404, and FTL 406. It is noted that the inputs to multiplexers 415, 417, and 419 may depend on particular trellis structures, and therefore, the PSP variables used as inputs to multiplexers 415, 417, and 419 have been shown with generic indices i, j, whose precise values may vary based on the trellis structure in particular implementations.

In exemplary aspects, the PSP algorithm uses two memories for each PSP variable in each Phase Corrector, DFD, and FTL block to ensure that a particular PSP variable is not overwritten in the reordering phase before the value of the PSP variable is used to update another PSP variable. Thus, when the PSP variables are updated serially the exemplary implementation of PSP 304 can retain a copy of the PSP variables until the end of the memory reordering phase.

In some aspects, it is possible to save on memory space (e.g., reduce a set of registers used to store the PSP variables) by performing all memory updates at the same time. In these cases, reload 408 for all Phase Corrector, DFD, and FTL block can be asserted at the same time, causing the internal memories to be updated simultaneously before the variables are used for implementing the PSP computations in the reordering phase. After the reordering phase, the Phase Corrector, DFD, and FTL blocks can continue to update their respective internal memories using the received inputs c₀, c₁, . . . c_{Nb-1} 310. In these implementations, the internal memory of the DFD blocks (e.g., DFD 404) can be updated every R samples of inputs c₀, c₁, . . . c_{Nb-1} 310, while the internal memories of the Phase Corrector and FTL blocks (e.g., Phase Corrector 402 and FTL 406) can be updated for every received sample. For branch b₀, for example, DFD 404 can also calculate the branch metric increment λ₀, which is already used by VA 306.

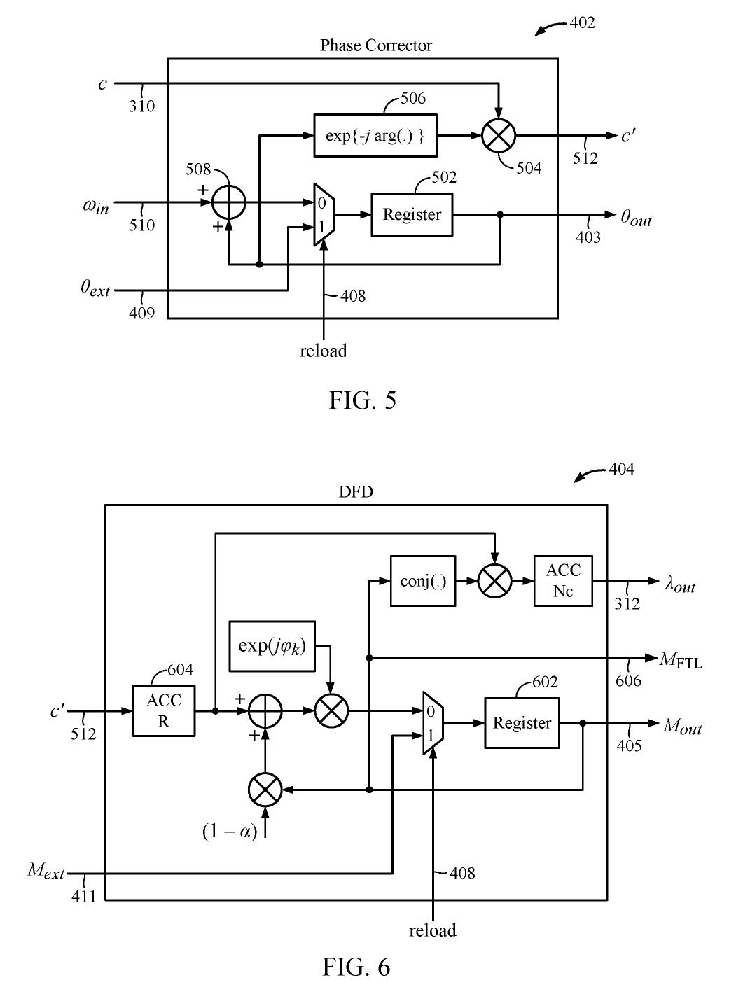

With reference now to FIGS. 5-7, further details of Phase Corrector 402, DFD 404, and FTL 406 according to example implementations, are shown.

As seen from FIG. 5, Phase Corrector 402 comprises inputs c₀ 310, θₑₓₜ 409, frequency estimate ωᵢₙ 510, and reload 408. Register 502 comprises the one or more internal memories of Phase Corrector 402, as previously discussed. Block 504 of Phase Corrector 402 rotates the corresponding matched filter output or input c₀ 310 by the latest phase estimate for θ₀ provided by block 506 to generate rotated output c′ 512. Additionally, accumulator 508 converts frequency estimate ωᵢₙ 510 to phase estimate θₒᵤₜ 403. Phase estimate θₒᵤₜ 403 is stored in register 502, as previously noted, to ensure that estimate θₒᵤₜ 403 is not overwritten during the reordering phase. Phase estimate θₒᵤₜ 403 is also supplied as the output (specifically, estimate θ₀ 403) of Phase Corrector 402.

From FIG. 6, DFD 404 is seen to accept phase corrected matched filter output or rotated output c′ 512 from Phase Corrector 402, and previously described memory value Mₑₓₜ 411. Register 602, or the memory of DFD 404 is updated with rotated output c′ 512. The update to register 602 is done at the coded bits rate, which is every R GFSK symbols in exemplary aspects. The down-sampling from every R GFSK symbols to one value is performed in the block shown as ACC R 604, which accumulates every R incoming samples of rotated output c′ 512. DFD 404 is configured to determine branch metric increments λ₀ 312 based, at least in part on the down-sampled output of ACC R 604. The estimate Mₒᵤₜ is read out from register 602 and provided as output M₀ 405 of DFD 404. DFD also provides output M_{FTL} 606 to FTL 406 which will be discussed next.

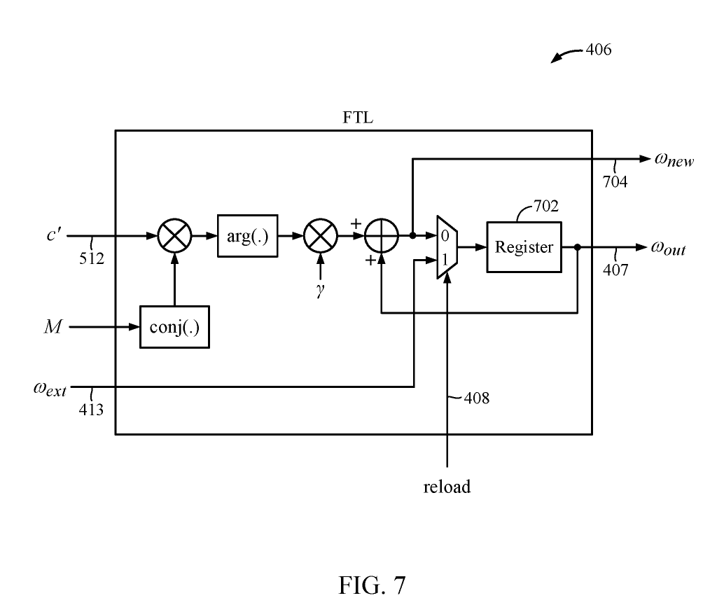

From FIG. 7 it is seen that FTL 406 accepts input ωₑₓₜ 413 and provides an update of frequency estimate ωₒᵤₜ at output ω₀ 407 (e.g., based on the equation \hat{ω}ₙ₊₁=\hat{ω}ₙ+γeₙ). FTL 406 also receives input rotated output c′ 512 from Phase Corrector 402 and M_{FTL} 606 from DFD 404 and provides two outputs, the aforementioned ω₀ 407, as well as ω_{new} 704, which are used for updates other FTL blocks and of Phase Corrector 402, respectively, in the reordering phase.

In exemplary aspects of this disclosure, a training sequence may be used for the PSP algorithm implemented by receiver 112 during a training mode. Receiver 112 may be operated in the training mode, for example, at the start of each packet of received signals. The training sequence can be used for training the various components of receiver 112 discussed above with reference to FIGS. 3-7.

In some aspects, it is seen that the maximum likelihood path for branches of the trellis can be determined from the transmitted data, and only the channel phase may remain to be estimated in frequency/phase tracking using the PSP algorithm. Therefore, frequency/phase tracking can be performed using only one branch during the training mode, e.g. branch b₀ corresponding to row 400 of FIG. 4. In the training mode, a specific matched filter output can be determined from an example training sequence, and this matched filter output can be input to a first branch, branch b₀, e.g., as c₀ 310. Once the training sequence is completed, the internal registers of other branches of PSP 304 can be updated with corresponding values of internal registers of branch b0 (e.g., registers 502, 602, and 702 of Phase Corrector 402, DFD 404, and FTL 406, respectively).

In an alternative aspect, all N_{b} branches of PSP 304 receive their corresponding matched filter outputs, i.e. c₀, c₁, . . . c_{Nb-1}, similar to the regular mode of operation. However, the N_{b} branches of PSP 304 use pre-computed decision from a corresponding set of N_{b} decisions, denoted, for example, as d″₀, d″₁, . . . d″_{Nb-1} (not specifically illustrated), wherein the pre-computed decisions are computed and stored in advance, based, for example, on the known training sequence instead of the N_{b} decisions d′₀, d′₁, . . . d′_{Nb-1} 414 derived from VA decisions on winner branches d₀, d₁, . . . d_{Ns-1} 314 provided by VA 306. In this aspect, all branches can operate on the same input and thus copying the register values from a first branch such as branch b₀ to the remaining branches after the training mode can be avoided.

In some aspects, computational resources used for implementing the exemplary PSP algorithm can be reduced in receiver 112, based, for example, the observation that a number of possible output bit sequences of a convolutional encoder (e.g., encoder 104 of transmitter 102 discussed with reference to FIG. 1) per state transition can be smaller than the number of trellis branches of the convolutional code.

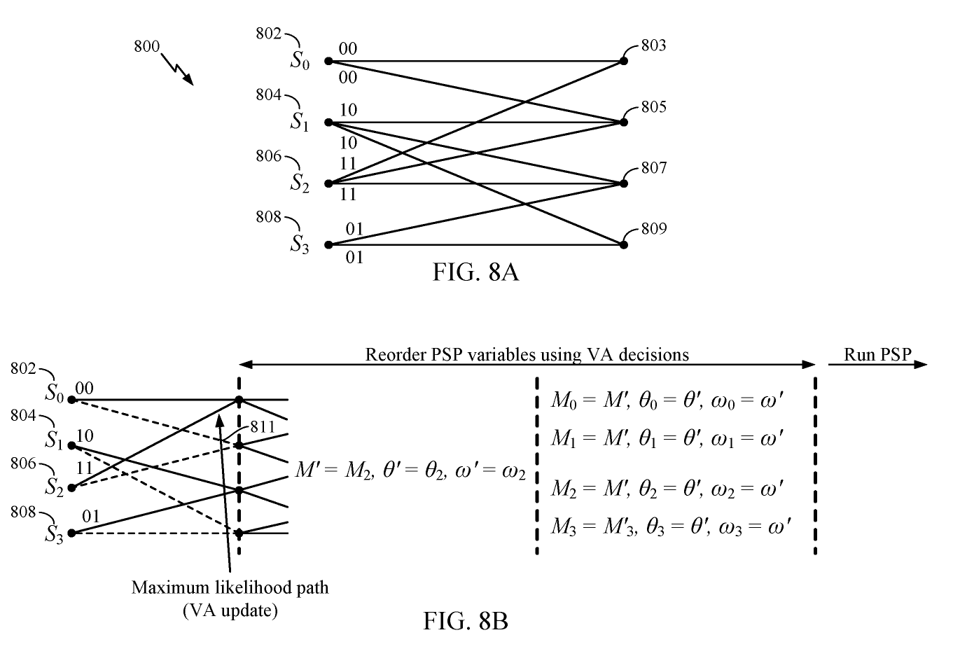

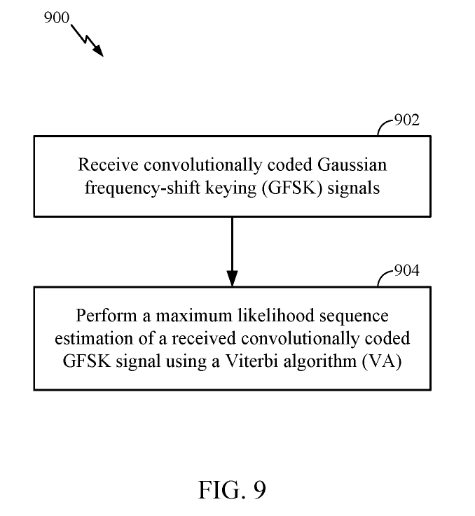

For example, FIG. 8A, illustrates trellis 800, with four states S₀ 802, S1 804, S2 806, and S3 808 shown. The eight possible transitions to states 803, 805, 807, and 809 have only four unique output bits (“00,” “10,” “11,” and “01”). These unique output bits are referred to as the number of possible code word combinations N_{w}=4. Accordingly, since the convolutionally coded GFSK signal transmitted by transmitter 102 is similar over branches for which the code words are the same, branches which have the same code word are grouped into a single branch to be processed using a single set of Phase Corrector, DFD, and FTL blocks (e.g., two or more branches are processed in row 400 of FIG. 4). Thus, the number of rows or sets of the Phase Corrector, DFD, and FTL blocks and their associated memories can be reduced from N_{b} (e.g., equal to 16, per FIG. 4) to N_{w} (e.g., equal to 4, by processing a single branch for every four similar branches).

With reference to FIG. 8B, trellis 800 of FIG. 8A is shown with reduced complexity based on the above grouping. For example, since each branch does not have individual PSP variables with it, the associated reordering scheme may be modified. In the illustrated aspect of FIG. 8B, PSP variables for all branches are updated with PSP variables of the branch that is associated with the winner branch of the state for which the state metric is maximum, according to VA 306, for example. The winner branch represents the maximum likelihood path. Among the four groups of two branches pertaining to states S₀ 802, S1 804, S2 806, and S3 808, the two branches comprised in of each of the four groups have identical output code words (i.e., there are only four branches out of the eight branches in the four groups, with unique code words “00,” “10,” “11,” and “01”). PSP is performed on only one branch from each group. Once decisions from VA 306 are received about the winner branch, all four branches with unique code words are updated with PSP variables corresponding to the maximum likelihood path 811.

Accordingly, it will be appreciated that exemplary aspects include various methods for performing the processes, functions and/or algorithms disclosed herein. For example, FIG. 9 illustrates method 900 of operating a receiver, e.g., receiver 112 discussed above.

In Block 902, method 900 includes receiving convolutionally coded Gaussian Frequency-Shift Keying (GFSK) signals (e.g., at matched filter bank 302).

In Block 904, method 900 includes performing a maximum likelihood sequence estimation (MLSE) of a received convolutionally coded GFSK signal using a Viterbi Algorithm (VA) (e.g., in VA 306, using branch increments from PSP 304).

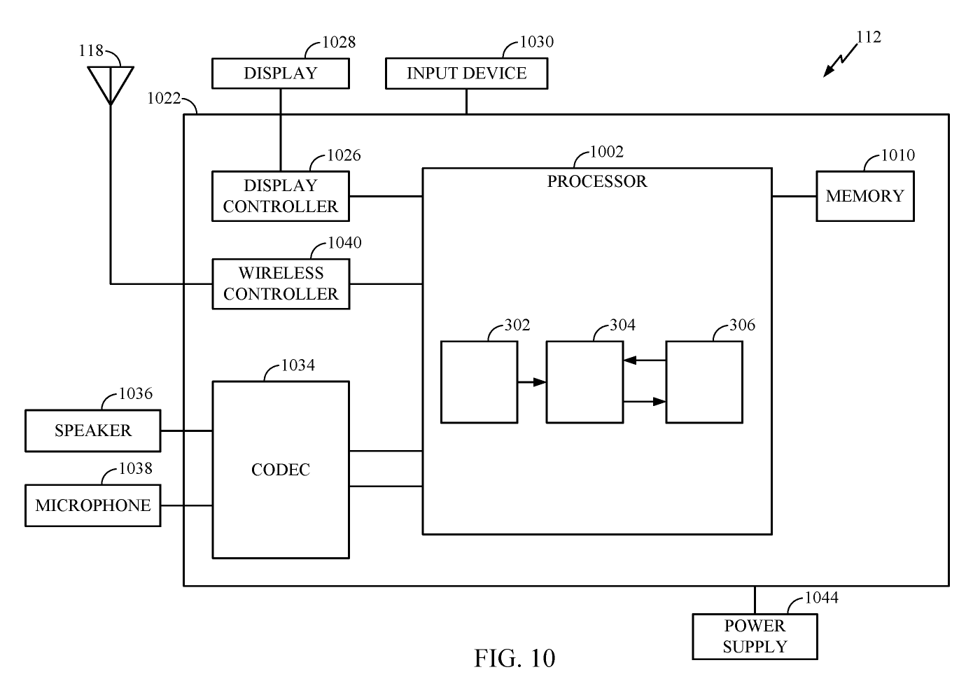

An example configuration of receiver 112 will now be discussed in relation to FIG. 10. FIG. 10 shows a block diagram of receiver 112, which can be a wireless device configured according to exemplary aspects. For example, receiver 112 of FIG. 10 can be configured to perform method 900 of FIG. 9 in some aspects. In further detail, receiver 112 is shown to include processor 1002, which can be, for example, a digital signal processor (DSP) or any general purpose processor or central processing unit (CPU) as known in the art. In FIG. 10, matched filter bank 302, PSP 304, and VA 306 of FIG. 3 are shown as blocks within processor 1002 while omitting further details of these blocks and interconnections thereof, for the sake of clarity. However, it will be understood that the implementation of receiver 112 discussed with reference to FIGS. 3-9 are applicable to the implementation shown in FIG. 10. Processor 1002 may be communicatively coupled to memory 1010, as shown.

FIG. 10 also shows display controller 1026 that is coupled to processor 1002 and to display 1028. Coder/decoder (CODEC) 1034 (e.g., an audio and/or voice CODEC) can be coupled to processor 1002. Other components, such as wireless controller 1040 (which may include a modem) are also illustrated. Speaker 1036 and microphone 1038 can be coupled to CODEC 1034. FIG. 10 also indicates that wireless controller 1040 can be coupled to wireless antenna 118. In a particular aspect, processor 1002, display controller 1026, memory 1010, CODEC 1034, and wireless controller 1040 are included in a system-in-package or system-on-chip device 1022.

In a particular aspect, input device 1030 and power supply 1044 are coupled to the system-on-chip device 1022. Moreover, in a particular aspect, as illustrated in FIG. 10, display 1028, input device 1030, speaker 1036, microphone 1038, wireless antenna 1042, and power supply 1044 are external to the system-on-chip device 1022. However, each of display 1028, input device 1030, speaker 1036, microphone 1038, wireless antenna 1042, and power supply 1044 can be coupled to a component of the system-on-chip device 1022, such as an interface or a controller.

It should be noted that although FIG. 10 depicts a wireless communications device, processor 1002 and memory 1010, may also be integrated into a set top box, a music player, a video player, an entertainment unit, a navigation device, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for detecting convolutionally coded GFSK signals. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

1. A method of operating a receiver, the method comprising:
receiving convolutionally coded Gaussian Frequency-Shift Keying (GFSK) signals; and
performing a maximum likelihood sequence estimation (MLSE) of the received convolutionally coded GFSK signals using a Viterbi Algorithm (VA), wherein the convolutionally coded GFSK signals comprise convolutionally coded bits spread over two or more GFSK symbols,
wherein a trellis of the convolutionally coded GFSK signals comprises two or more branches, and
wherein performing the MLSE of the received convolutionally coded GFSK signal using the Viterbi algorithm (VA) comprises Per-Survivor Processing (PSP) of the received convolutionally coded GFSK signals to generate, for each branch of the trellis, a frequency estimate, a phase estimate, and a branch metric increment for the VA.

2-3. (canceled)

4. The method of claim 1, wherein PSP of the received convolutionally coded GFSK signals to generate the branch increment for each branch of the trellis comprises using a decision feedback demodulator (DFD) to compute the branch metric increment for each branch of the trellis.

5. The method of claim 4, wherein PSP of the received convolutionally coded GFSK signals to generate the frequency estimate for each branch of the trellis comprises applying a Frequency Tracking Loop (FTL) to compute the frequency estimate for each branch of the trellis.

6-7. (canceled)

8. The method of claim 2, comprising sampling the received convolutionally coded GFSK signals at a GFSK symbol rate.

9. The method of claim 8, further comprising generating matched filter outputs associated with the convolutionally coded GFSK signals based on the sampling for each branch of the trellis.

10. The method of claim 2, comprising, in a training mode, determining a maximum likelihood path for the two or more branches of the trellis based on the received convolutionally coded GFSK symbols using a Per-Survivor Processing (PSP) of the received convolutionally coded GFSK signals to generate a frequency estimate and a phase estimate of the two or more branches.

11. The method of claim 10, comprising determining a matched filter output for a first branch of the two or more branches based on a training sequence and updating matched filter outputs of remaining branches of the two or more branches based on the matched filter output of the first branch.

12. The method of claim 10, comprising determining matched filter outputs for a first branch of the two or more branches based on pre-computed decisions for the VA.

13. The method of claim, further comprising grouping two or more branches of the trellis into groups of branches having a same code word.

14. The method of claim 13 further comprising determining a winner branch of a group of branches based on the VA, performing Per-Survivor Processing (PSP) of the winner branch and updating frequency estimates, phase estimates, and branch metric increments of remaining branches of the group of branches with the corresponding frequency estimate, phase estimate, and branch metric increment of the winner branch.

15. An apparatus comprising:
a receiver configured to:
receive convolutionally coded Gaussian Frequency-Shift Keying (GFSK) signals; and
perform a maximum likelihood sequence estimation (MLSE) of the received convolutionally coded GFSK signals using a Viterbi Algorithm (VA), wherein the convolutionally coded GFSK signals comprise convolutionally coded bits spread over two or more GFSK symbols, wherein a trellis of the convolutionally coded GFSK signals comprises two or more branches; and
wherein the receiver comprises a Per-Survivor Processing (PSP) circuit configured to perform PSP of the received convolutionally coded GFSK signals and generate, for each branch of the trellis, a frequency estimate, a phase estimate, and a branch metric increment for the VA.

16-17. (canceled)

18. The apparatus of claim 15, wherein the PSP circuit comprises a decision feedback demodulator (DFD) circuit for each branch of the trellis, configured to compute the branch metric increment for the corresponding branch.

19. The apparatus of claim 17, wherein the PSP circuit comprises a Frequency Tracking Loop (FTL) circuit for each branch of the trellis, configured to compute the frequency estimate for the corresponding branch.

20-21. (canceled)

22. The apparatus of claim 16, wherein the receiver comprises a matched filter bank configured to sample the received convolutionally coded GFSK signals at a GFSK symbol rate.

23. The apparatus of claim 22, wherein the matched filter bank is further configured to generate matched filter outputs for each branch of the trellis based on the sampled convolutionally coded GFSK signals.

24. The apparatus of claim 16, wherein, wherein the receiver comprises a Per-Survivor Processing (PSP) circuit configured, in a training mode, to perform PSP of the received convolutionally coded GFSK signals to generate a frequency estimate and a phase estimate of the two or more branches.

25. The apparatus of claim 24, wherein the receiver is configured to determine a matched filter output for a first branch of the two or more branches based on a training sequence and update matched filter outputs of remaining branches of the two or more branches based on the matched filter output of the first branch.

26. The apparatus of claim 25, wherein matched filter outputs for a first branch of the two or more branches are based on pre-computed decisions for the VA.

27. The apparatus of claim 16, wherein the receiver is configured to group branches of the two or more branches of the trellis into groups of branches which have a same code word.

28. The apparatus of claim 27, wherein the receiver is configured to determine a winner branch of a group of branches based on the VA, and a Per-Survivor Processing (PSP) circuit is configured to perform PSP of the winner branch to update frequency estimates, phase estimates, and branch metric increments of remaining branches of the group of branches with the corresponding frequency estimate, phase estimate, and branch metric increment of the winner branch.

29. An apparatus comprising:
means for receiving convolutionally coded Gaussian Frequency-Shift Keying (GFSK) signals; and
means for performing a maximum likelihood sequence estimation (MLSE) of the received convolutionally coded GFSK signals using a Viterbi Algorithm (VA), wherein the convolutionally coded GFSK signals comprise convolutionally coded bits spread over two or more GFSK symbols,
wherein a trellis of the convolutionally coded GFSK signals comprises two or more branches, and
means for performing a Per-Survivor Processing (PSP) of the received convolutionally coded GFSK signals and generating, for each branch of the trellis, a frequency estimate, a phase estimate, and a branch metric increment for the VA.

30. (canceled)
